(19) United States
(12) Patent Application Publication
(10) Pub. No.: US 2024/0402349 A1
(43) Pub. Date: Dec. 5, 2024

(54) DELTA-IONOSPHERE COMPENSATED DIFFERENTIAL CARRIER PHASE (DCP) UPDATE

(71) Applicant: QUALCOMM Incorporated, San Diego, CA (US)

(72) Inventor: Min WANG, Tustin, CA (US)

(21) Appl. No.: 18/328,669

(22) Filed: Jun. 2, 2023

(51) Int. Cl. G01S 19/07; G01S 19/29

(52) U.S. Cl. CPC G01S 19/072; G01S 19/29

(57) ABSTRACT

In some implementations, measurement information regarding first and second dual-band carrier phase measurements may be obtained, wherein: the first and second dual-band carrier phase measurements are of radio frequency (RF) signals transmitted by a satellite using first and second frequency bands, and the first dual-band carrier phase measurement is performed by a device at a first epoch and the second dual-band carrier phase measurement is performed by the device at a second epoch subsequent to the first epoch. A change in an ionospheric error value from the first epoch to the second epoch may be determined based on a difference between the measurement information regarding the first and second dual-band carrier phase measurements. An indication of the change in the ionospheric error value may be provided.

### BACKGROUND

### 1. Field of Disclosure

The present disclosure relates generally to the field of mobile device positioning using radio frequency (RF) signals, and more specifically to global navigation satellite system (GNSS)-based positioning.

### 2. Description of Related Art

The global navigation satellite system (GNSS) is widely used for positioning consumer electronic devices such as smartphones, as well as for positioning vehicles such as cars, trucks, ships, and aircraft. High-accuracy positioning can provide significant value to various modern-day positioning-based applications. For example, an autonomous driving application may benefit from meter-level positioning information that enables it to determine which particular lane of a road an autonomously-driven vehicle is in and may further benefit from sub-meter-level positioning information that enables it to determine where that vehicle is located within the lane.

High-accuracy positioning of a mobile device may involve the use of a precise positioning engine (PPE) at the mobile device to generate high-accuracy positioning information based on GNSS measurements and error correction data. The error correction data may be received at the mobile device from a high-accuracy positioning service, such as a precise point positioning (PPP) or real-time kinematic (RTK) positioning service. If the error correction data becomes unavailable (for example, due to a service outage), then the PPE may be capable of using differential carrier phase (DCP) updates and/or other data (e.g., space representation (SSR) PPE estimation and/or satellite-based augmentation system (SBAS) information) to continue to generate high-accuracy positioning information. However, the accuracy of such information may deteriorate over time, due to the accumulation of errors such as ionosphere delay.

### BRIEF SUMMARY

An example method of enabling ionospheric error compensation in global navigation satellite system (GNSS)-based positioning, according to this disclosure, may comprise obtaining measurement information regarding a first dual-band carrier phase measurement and measurement information regarding a second dual-band carrier phase measurement, wherein the first dual-band carrier phase measurement and the second dual-band carrier phase measurement are of radio frequency (RF) signals transmitted by a satellite using a first frequency band and a second frequency band, and the first dual-band carrier phase measurement is performed by a first at a first epoch and the second dual-band carrier phase measurement is performed by the first device at a second epoch subsequent to the first epoch. The method also may comprise determining a change in an ionospheric error value from the first epoch to the second epoch based on a difference between the measurement information regarding the first dual-band carrier phase measurement and the measurement information regarding the second dual-band carrier phase measurement. The method also may comprise outputting an indication of the change in the ionospheric error value.

An example global navigation satellite system (GNSS) device comprising: a GNSS receiver, one or more memories, one or more processors communicatively coupled with the GNSS receiver and the one or more memories, wherein the one or more processors are configured to obtain, via the GNSS receiver, measurement information regarding a first dual-band carrier phase measurement and measurement information regarding a second dual-band carrier phase measurement, wherein: the first dual-band carrier phase measurement and the second dual-band carrier phase measurement are of radio frequency (RF) signals transmitted by a satellite using a first frequency band and a second frequency band, and the first dual-band carrier phase measurement is performed by the GNSS device at a first epoch and the second dual-band carrier phase measurement is performed by the GNSS device at a second epoch subsequent to the first epoch. The one or more processors further may be configured to determine a change in an ionospheric error value from the first epoch to the second epoch based on a difference between the measurement information regarding the first dual-band carrier phase measurement and the measurement information regarding the second dual-band carrier phase measurement. The one or more processors further may be configured to output an indication of the change in the ionospheric error value.

An example apparatus for enabling ionospheric error compensation in global navigation satellite system (GNSS)-based positioning, according to this disclosure, may comprise means for obtaining measurement information regarding a first dual-band carrier phase measurement and measurement information regarding a second dual-band carrier phase measurement, wherein: the first dual-band carrier phase measurement and the second dual-band carrier phase measurement are of radio frequency (RF) signals transmitted by a satellite using a first frequency band and a second frequency band, and the first dual-band carrier phase measurement is performed by a first device at a first epoch and the second dual-band carrier phase measurement is performed by the first device at a second epoch subsequent to the first epoch. The apparatus further may comprise means for determining a change in an ionospheric error value from the first epoch to the second epoch based on a difference between the measurement information regarding the first dual-band carrier phase measurement and the measurement information regarding the second dual-band carrier phase measurement. The apparatus further may comprise means for outputting an indication of the change in the ionospheric error value.

According to this disclosure, an example non-transitory computer-readable medium stores instructions for enabling ionospheric error compensation in global navigation satellite system (GNSS)-based positioning, the instructions comprising code for obtaining measurement information regarding a first dual-band carrier phase measurement and measurement information regarding a second dual-band carrier phase measurement, wherein the first dual-band carrier phase measurement and the second dual-band carrier phase measurement are of radio frequency (RF) signals transmitted by a satellite using a first frequency band and a second frequency band, and the first dual-band carrier phase measurement is performed by a first device at a first epoch and the second dual-band carrier phase measurement is performed by the first device at a second epoch subsequent to the first epoch. The instructions further may comprise code for determining a change in an ionospheric error value from the first epoch to the second epoch based on a difference between the measurement information regarding the first dual-band carrier phase measurement and the measurement information regarding the second dual-band carrier phase measurement. The instructions further may comprise code for outputting an indication of the change in the ionospheric error value.

This summary is neither intended to identify key or essential features of the claimed subject matter nor is it intended to be used in isolation to determine the scope of the claimed subject matter. The subject matter should be understood by reference to appropriate portions of the entire specification of this disclosure, any or all drawings, and each claim. The foregoing, together with other features and examples, will be described in more detail below in the following specification, claims, and accompanying drawings.

### BRIEF DESCRIPTION OF THE DRAWINGS

FIG. 1 is a diagram of a positioning system, according to an embodiment.

FIG. 2 is a simplified diagram of a global navigation satellite system (GNSS) system, according to an embodiment.

FIG. 3 is a block diagram illustrating an example positioning scheme, according to aspects of the disclosure.

FIG. 4 is a block diagram illustrating an example operating environment, according to aspects of the disclosure.

FIG. 5 is a diagram of an example plot of DCP accumulated horizontal error (HE) over time, for an example set of GNSS measurements.

FIG. 6 is a diagram of an example plot of DCP accumulated HE using the same underlying GNSS data as used in the diagram of FIG. 5, but with delta ionosphere correction applied.

FIG. 7 is a flow diagram illustrating an example method of enabling ionospheric error compensation in GNSS-based positioning, according to aspects of the disclosure.

FIG. 8 is a block diagram of an embodiment of a GNSS device, which can be utilized in embodiments as described herein.

Like reference symbols in the various drawings indicate like elements, in accordance with certain example implementations. In addition, multiple instances of an element may be indicated by following a first number for the element with a letter or a hyphen and a second number. For example, multiple instances of an element 110 may be indicated as 110-1, 110-2, 110-3, etc., or as 110a, 110b, 110c, etc. When referring to such an element using only the first number, any instance of the element is to be understood (e.g., element 110 in the previous example would refer to elements 110-1, 110-2, and 110-3 or to elements 110a, 110b, and 110c).

### DETAILED DESCRIPTION

Several illustrative examples will now be described with respect to the accompanying drawings, which form a part hereof. While particular examples, in which one or more aspects of the disclosure may be implemented, are described below, other examples may be used, and various modifications may be made, without departing from the scope of the disclosure.

Reference throughout this specification to “one example” or “an example” means that a particular feature, structure, or characteristic described in connection with the example is included in at least one example of claimed subject matter. Thus, the appearances of the phrase “in one example” or “an example” in various places throughout this specification are not necessarily all referring to the same example. Furthermore, the particular features, structures, or characteristics may be combined in one or more examples.

The methodologies described herein may be implemented by various means depending upon applications according to particular examples. For example, such methodologies may be implemented in hardware, firmware, software, and/or combinations thereof. In a hardware implementation, for example, a processing unit may be implemented within one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other devices units designed to perform the functions described herein, and/or combinations thereof.

As used herein, the terms “mobile device” and “User Equipment” (UE) may be used interchangeably and are not intended to be specific or otherwise limited to any particular Radio Access Technology (RAT), unless otherwise noted. In general, a mobile device and/or UE may be any wireless communication device (e.g., a mobile phone, router, tablet computer, laptop computer, tracking device, wearable (e.g., smartwatch, glasses, Augmented Reality (AR)/Virtual Reality (VR) headset, etc.), vehicle (e.g., automobile, vessel, aircraft motorcycle, bicycle, etc.), Internet of Things (IoT) device, etc.), or another electronic device that may be used for Global Navigation Satellite Systems (GNSS) positioning as described herein. According to some embodiments, a mobile device and/or UE may be used to communicate over a wireless communications network. A UE may be mobile or may (e.g., at certain times) be stationary, and may communicate with a Radio Access Network (RAN). As used herein, the term UE may be referred to interchangeably as an Access Terminal (AT), a client device, a wireless device, a subscriber device, a subscriber terminal, a subscriber station, a user terminal (UT), a mobile device, a mobile terminal, a mobile station, or variations thereof. Generally, UEs can communicate with a core network via a RAN, and through the core network, the UEs can be connected with external networks (such as the Internet) and with other UEs. Other mechanisms of connecting to the core network and/or the Internet are also possible for the UEs, such as over wired access networks, wireless local area network (WLAN) networks (e.g., based on the Institute of Electrical and Electronics Engineers (IEEE) 802.11 standard, etc.), and so on.

A “space vehicle” (SV) as referred to herein, relates to an object that is capable of transmitting signals to receivers on the earth's surface. In one particular example, such an SV may comprise a geostationary satellite. Alternatively, an SV may comprise a satellite traveling in an orbit and moving relative to a stationary position on the Earth. However, these are merely examples of SVs, and claimed subject matter is not limited in these respects. SVs also may be referred to herein simply as “satellites.”

As described herein, a GNSS receiver may comprise and/or be incorporated into an electronic device. This may include a single entity or may include multiple entities such as in a personal area network where a user may employ audio, video, and/or data I/O devices and/or body sensors and a separate wireline or wireless modem. As described herein, an estimate of the location of a GNSS receiver may be referred to as a location, location estimate, location fix, fix, position, position estimate, or position fix, and may be geodetic, thus providing location coordinates for the GPS receiver (e.g., latitude and longitude) which may or may not include an altitude component (e.g., height above sea level, height above or depth below ground level, floor level or basement level). In some embodiments, a location of the GPS receiver and/or an electronic device comprising the GPS receiver may also be expressed as an area or volume (defined either geodetically or in civic form) within which the GPS receiver is expected to be located with some probability or confidence level (e.g., 67%, 95%, etc.). In the description contained herein, the use of the term location may comprise any of these variants unless indicated otherwise. When computing the location of a GPS receiver, such computations may solve for local X, Y, and possibly Z coordinates and then, if needed, convert the coordinates from one coordinate frame to another.

Various aspects relate generally to the use of differential carrier phase (DCP) updates to maintain the accuracy of positioning observations obtained via a precise positioning engine (PPE) positioning procedure, such as precise point positioning (PPP) or real-time kinematic (RTK) positioning, in the absence of error correction data. Some aspects more specifically relate to reducing or removing the accumulation of ionosphere error while using DCP updates for positioning by determining and compensating for the change in ionosphere error over time (which may be referred to herein as “delta ionosphere,” “dlono,” or similar terms). In some examples, delta ionosphere compensation can be calculated from successive dual-band carrier phase measurements in which geometry and receiver clock terms can be canceled out. The delta ionosphere term can be applied to a DCP update and/or shared with other devices (e.g., a device that makes single-band carrier phase measurements). In some embodiments, delta ionosphere information additionally or alternatively can be included in other (non-DCP) information, such as state space representation (SSR) data and/or satellite-based augmentation system (SBAS) information. By determining and compensating for delta ionosphere error over time, embodiments can enable highly-accurate positioning observations in the absence of correction data, and the overall positioning accuracy of the GNSS-based positioning engine (PPE) can be enhanced.

Embodiments for determining and applying delta ionosphere compensation are provided in detail hereafter, following a review of applicable technology.

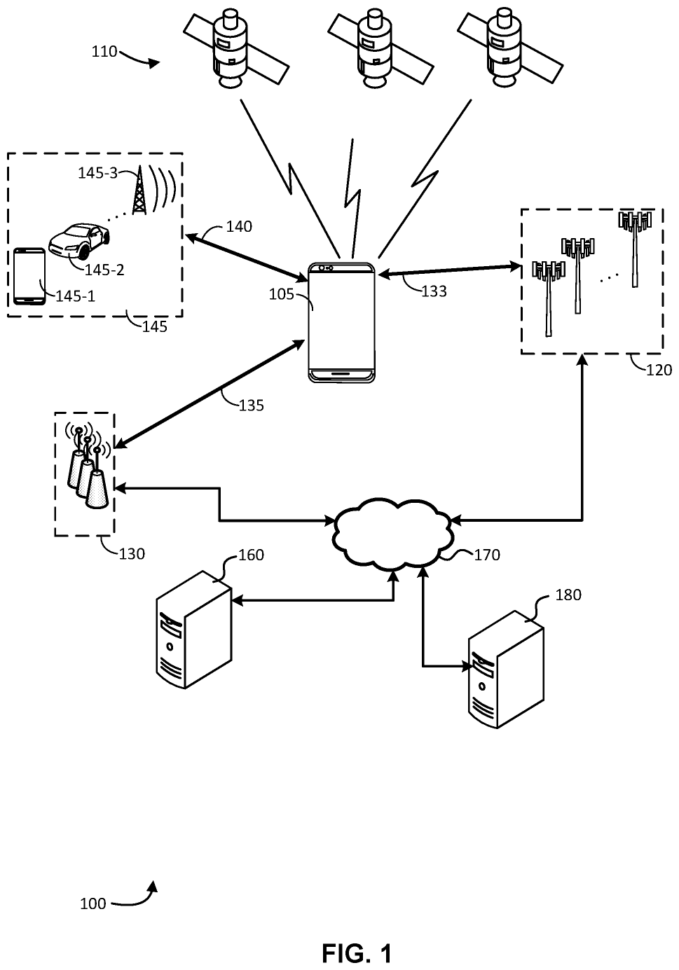

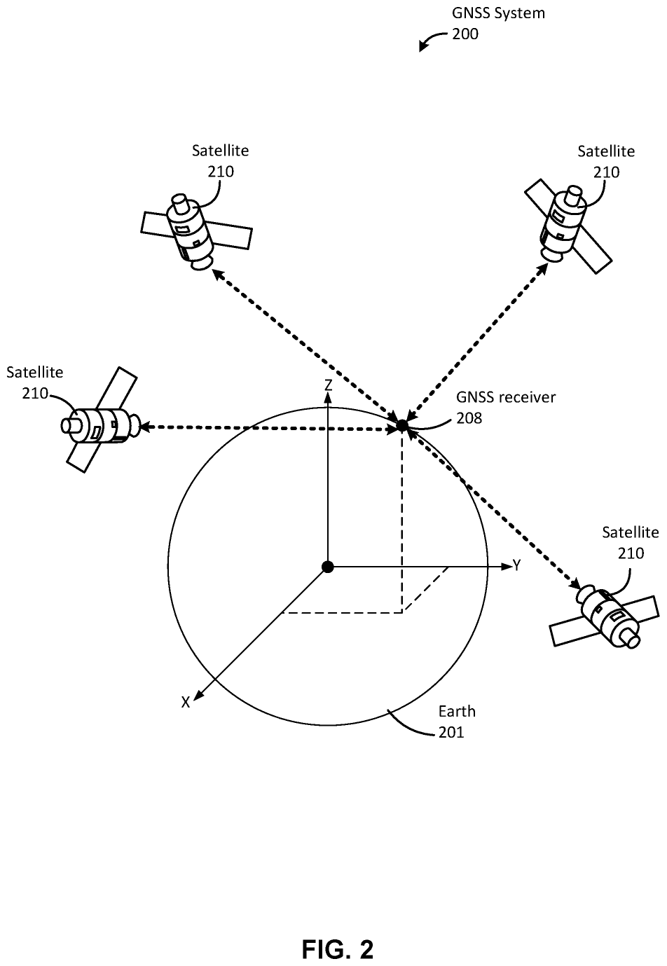

FIG. 1 is a simplified illustration of a positioning system 100 in which a mobile device 105, location server 160, and/or other components of the positioning system 100 can use the techniques provided herein for precise positioning using delta ionosphere compensation, according to an embodiment. The techniques described herein may be implemented by one or more components of the positioning system 100. The positioning system 100 can include a mobile device 105; one or more satellites 110 (also referred to as space vehicles (SVs)) for a GNSS such as the GPS, GLONASS (GLO), Galileo (GAL), or BeiDou Navigation Satellite System (BDS); base stations 120; access points (APs) 130; location server 160; network 170; and external client 180. Generally put, the positioning system 100 can estimate the location of the mobile device 105 based on radio frequency (RF) signals received by and/or sent from the mobile device 105 and known locations of other components (e.g., GNSS satellites 110, base stations 120, APs 130) transmitting and/or receiving the RF signals. Additional details regarding particular location estimation techniques are discussed in more detail with regard to FIG. 2.

In this example, FIG. 1 illustrates the mobile device 105 as a smartphone device, however, mobile devices may be any suitable device that includes GNSS capabilities or may be a device or machine into which such GNSS capabilities are integrated. Thus, a mobile device 105 may include personal devices such as a smartphone, smartwatch, tablet, laptop, etc. However, mobile devices may include a larger class of devices as well and may include vehicles with integrated GNSS receivers and positioning systems, such as boats or ships, cars, trucks, aircraft, shipping containers, etc. As noted, in certain contexts, such as in reference to a cellular network, the mobile device 105 may be referred to as a UE.

It should be noted that FIG. 1 provides only a generalized illustration of various components, any or all of which may be utilized as appropriate, and each of which may be duplicated as necessary. Specifically, although only one mobile device 105 is illustrated, it will be understood that many mobile devices (e.g., hundreds, thousands, millions, etc.) may utilize the positioning system 100. Similarly, the positioning system 100 may include a larger or smaller number of base stations 120 and/or APs 130 than illustrated in FIG. 1. The illustrated connections that connect the various components in the positioning system 100 comprise data and signaling connections which may include additional (intermediary) components, direct or indirect physical and/or wireless connections, and/or additional networks. Furthermore, components may be rearranged, combined, separated, substituted, and/or omitted, depending on desired functionality. In some embodiments, for example, the external client 180 may be directly connected to location server 160. A person of ordinary skill in the art will recognize many modifications to the components illustrated.

Depending on desired functionality, the network 170 may comprise any of a variety of wireless and/or wireline networks. The network 170 can, for example, comprise any combination of public and/or private networks, local and/or wide-area networks, and the like. Furthermore, the network 170 may utilize one or more wired and/or wireless communication technologies. In some embodiments, the network 170 may comprise a cellular or other mobile network, a wireless local area network (WLAN), a wireless wide-area network (WWAN), and/or the Internet, for example. Examples of network 170 include a Long-Term Evolution (LTE) wireless network, a Fifth Generation (5G) wireless network (also referred to as New Radio (NR) wireless network or 5G NR wireless network), a Wi-Fi WLAN, and the Internet. LTE, 5G, and NR are wireless technologies defined, or being defined, by the 3rd Generation Partnership Project (3GPP). Network 170 may also include more than one network and/or more than one type of network.

The base stations 120 and access points (APs) 130 may be communicatively coupled to the network 170. In some embodiments, the base station 120s may be owned, maintained, and/or operated by a cellular network provider, and may employ any of a variety of wireless technologies, as described herein below. Depending on the technology of the network 170, a base station 120 may comprise a node B, an Evolved Node B (cNodeB or eNB), a base transceiver station (BTS), a radio base station (RBS), an NR NodeB (gNB), a Next Generation eNB (ng-eNB), or the like. A base station 120 that is a gNB or ng-cNB may be part of a Next Generation Radio Access Network (NG-RAN) which may connect to a 5G Core Network (5GC) in the case that Network 170 is a 5G network. The functionality performed by a base station 120 in earlier-generation networks (e.g., 3G and 4G) may be separated into different functional components (e.g., radio units (RUS), distributed units (DUs), and central units (CUs)) and layers (e.g., L1/L2/L3) in view Open Radio Access Networks (O-RAN) and/or Virtualized Radio Access Network (V-RAN or vRAN) in 5G or later networks, which may be executed on different devices at different locations connected, for example, via fronthaul, midhaul, and backhaul connections. As referred to herein, a “base station” (or ng-eNB, gNB, etc.) may include any or all of these functional components. An AP 130 may comprise a Wi-Fi AP or a Bluetooth® AP or an AP having cellular capabilities (e.g., 4G LTE and/or 5G NR), for example. Thus, mobile device 105 can send and receive information with network-connected devices, such as location server 160, by accessing the network 170 via a base station 120 using a first communication link 133. Additionally or alternatively, because APs 130 also may be communicatively coupled with the network 170, mobile device 105 may communicate with network-connected and Internet-connected devices, including location server 160, using a second communication link 135, or via one or more other mobile devices 145.

As used herein, the term “base station” may generically refer to a single physical transmission point, or multiple co-located physical transmission points, which may be located at a base station 120. A Transmission Reception Point (TRP) (also known as transmit/receive point) corresponds to this type of transmission point, and the term “TRP” may be used interchangeably herein with the terms “gNB,” “ng-eNB,” and “base station.” In some cases, a base station 120 may comprise multiple TRPs—e.g. with each TRP associated with a different antenna or a different antenna array for the base station 120. Physical transmission points may comprise an array of antennas of a base station 120 (e.g., as in a Multiple Input-Multiple Output (MIMO) system and/or where the base station employs beamforming). The term “base station” may additionally refer to multiple non-co-located physical transmission points, the physical transmission points may be a Distributed Antenna System (DAS) (a network of spatially separated antennas connected to a common source via a transport medium) or a Remote Radio Head (RRH) (a remote base station connected to a serving base station).

As used herein, the term “cell” may generically refer to a logical communication entity used for communication with a base station 120, and may be associated with an identifier for distinguishing neighboring cells (e.g., a Physical Cell Identifier (PCID), a Virtual Cell Identifier (VCID)) operating via the same or a different carrier. In some examples, a carrier may support multiple cells, and different cells may be configured according to different protocol types (e.g., Machine-Type Communication (MTC), Narrowband Internet-of-Things (NB-IoT), Enhanced Mobile Broadband (cMBB), or others) that may provide access for different types of devices. In some cases, the term “cell” may refer to a portion of a geographic coverage area (e.g., a sector) over which the logical entity operates.

The location server 160 may comprise a server and/or other computing device configured to determine an estimated location of mobile device 105 and/or provide data (e.g., “assistance data”) to mobile device 105 to facilitate location measurement and/or location determination by mobile device 105. According to some embodiments, location server 160 may comprise a Home Secure User Plane Location (SUPL) Location Platform (H-SLP), which may support the SUPL user plane (UP) location solution defined by the Open Mobile Alliance (OMA) and may support location services for mobile device 105 based on subscription information for mobile device 105 stored in location server 160. In some embodiments, the location server 160 may comprise, a Discovered SLP (D-SLP) or an Emergency SLP (E-SLP). The location server 160 may also comprise an Enhanced Serving Mobile Location Center (E-SMLC) that supports location of mobile device 105 using a control plane (CP) location solution for LTE radio access by mobile device 105. The location server 160 may further comprise a Location Management Function (LMF) that supports location of mobile device 105 using a control plane (CP) location solution for NR or LTE radio access by mobile device 105.

In a CP location solution, signaling to control and manage the location of mobile device 105 may be exchanged between elements of network 170 and with mobile device 105 using existing network interfaces and protocols and as signaling from the perspective of network 170. In a UP location solution, signaling to control and manage the location of mobile device 105 may be exchanged between location server 160 and mobile device 105 as data (e.g. data transported using the Internet Protocol (IP) and/or Transmission Control Protocol (TCP)) from the perspective of network 170.

As previously noted (and discussed in more detail below), the estimated location of mobile device 105 may be based on measurements of RF signals sent from and/or received by the mobile device 105. In particular, these measurements can provide information regarding the relative distance and/or angle of the mobile device 105 from one or more components in the positioning system 100 (e.g., GNSS satellites 110, APs 130, base stations 120). The estimated location of the mobile device 105 can be estimated geometrically (e.g., using multiangulation and/or multilateration), based on the distance and/or angle measurements, along with the known position of the one or more components.

Although terrestrial components such as APs 130 and base stations 120 may be fixed, embodiments are not so limited. Mobile components may be used. For example, in some embodiments, a location of the mobile device 105 may be estimated at least in part based on measurements of RF signals 140 communicated between the mobile device 105 and one or more other mobile devices 145, which may be mobile or fixed. As illustrated, other mobile devices may include, for example, a mobile phone 145-1, vehicle 145-2, and/or static communication/positioning device 145-3. When or more other mobile devices 145 are used in the position determination of a particular mobile device 105, the mobile device 105 for which the position is to be determined may be referred to as the “target mobile device,” and each of the one or more other mobile devices 145 used may be referred to as an “anchor mobile device.” For position determination of a target mobile device, the respective positions of the one or more anchor mobile devices may be known and/or jointly determined with the target mobile device. Direct communication between the one or more other mobile devices 145 and mobile device 105 may comprise sidelink and/or similar Device-to-Device (D2D) communication technologies. Sidelink, which is defined by 3GPP, is a form of D2D communication under the cellular-based LTE and NR standards.

According to some embodiments, such as when the mobile device 105 comprises and/or is incorporated into a vehicle, a form of D2D communication used by the mobile device 105 may comprise vehicle-to-everything (V2X) communication. V2X is a communication standard for vehicles and related entities to exchange information regarding a traffic environment. V2X can include vehicle-to-vehicle (V2V) communication between V2X-capable vehicles, vehicle-to-infrastructure (V21) communication between the vehicle and infrastructure-based devices (commonly termed roadside units (RSUs)), vehicle-to-person (V2P) communication between vehicles and nearby people (pedestrians, cyclists, and other road users), and the like. Further, V2X can use any of a variety of wireless RF communication technologies. Cellular V2X (CV2X), for example, is a form of V2X that uses cellular-based communication such as LTE (4G), NR (5G) and/or other cellular technologies in a direct-communication mode as defined by 3GPP. The mobile device 105 illustrated in FIG. 1 may correspond with a component or device on a vehicle, RSU, or other V2X entity that is used to communicate V2X messages. The static communication/positioning device 145-3 (which may correspond with an RSU) and/or the vehicle 145-2, therefore, may communicate with the mobile device 105 and may be used to determine the position of the mobile device 105 using techniques similar to those used by base stations 120 and/or APs 130 (e.g., using multiangulation and/or multilateration). It can be further noted that mobile devices 145 (which may include V2X devices), base stations 120, and/or APs 130 may be used together (e.g., in a WWAN positioning solution) to determine the position of the mobile device 105, according to some embodiments.

An estimated location of mobile device 105 can be used in a variety of applications—e.g. to assist direction finding or navigation for a user of mobile device 105 or to assist another user (e.g. associated with external client 180) to locate mobile device 105. A “location” is also referred to herein as a “location estimate”, “estimated location”, “location”, “position”, “position estimate”, “position fix”, “estimated position”, “location fix” or “fix”. The process of determining a location may be referred to as “positioning,” “position determination,” “location determination,” or the like. A location of mobile device 105 may comprise an absolute location of mobile device 105 (e.g. a latitude and longitude and possibly altitude) or a relative location of mobile device 105 (e.g. a location expressed as distances north or south, east or west and possibly above or below some other known fixed location (including, e.g., the location of a base station 120 or AP 130) or some other location such as a location for mobile device 105 at some known previous time, or a location of another mobile device 145 at some known previous time). As noted elsewhere herein, a location may be specified as a geodetic location comprising coordinates which may be absolute (e.g. latitude, longitude and optionally altitude), relative (e.g. relative to some known absolute location) or local (e.g. X, Y and optionally Z coordinates according to a coordinate system defined relative to a local area such a factory, warehouse, college campus, shopping mall, sports stadium or convention center). A location may instead be a civic location and may then comprise one or more of a street address (e.g. including names or labels for a country, state, county, city, road and/or street, and/or a road or street number), and/or a label or name for a place, building, portion of a building, floor of a building, and/or room inside a building etc. A location may further include an uncertainty or error indication, such as a horizontal and possibly vertical distance by which the location is expected to be in error or an indication of an area or volume (e.g. a circle or ellipse) within which mobile device 105 is expected to be located with some level of confidence (e.g. 95% confidence).

The external client 180 may be a web server or remote application that may have some association with mobile device 105 (e.g. may be accessed by a user of mobile device 105) or may be a server, application, or computer system providing a location service to some other user or users which may include obtaining and providing the location of mobile device 105 (e.g. to enable a service such as a friend or relative finder, or child or pet location). Additionally or alternatively, the external client 180 may obtain and provide the location of mobile device 105 to an emergency services provider, government agency, etc.

As noted, the mobile device 105 of FIG. 1 may be capable of GNSS positioning. Details regarding the GNSS positioning of a mobile device 105, or any device comprising a GNSS receiver, are provided hereafter with regard to FIG. 2.

FIG. 2 is a simplified diagram of a GNSS system 200, provided to illustrate how GNSS is generally used to determine an accurate location of a GNSS receiver 208 on earth 201. Put generally, the GNSS system 200 enables an accurate GNSS position fix of the GNSS receiver 208, which receives RF signals from GNSS satellites 210 (which may correspond with satellites 110 of FIG. 1) from one or more GNSS constellations. The types of GNSS receiver 208 used may vary, depending on the application. In some embodiments, for instance, the GNSS receiver 208 may comprise a standalone device or component incorporated into another device (e.g., mobile device 105 of FIG. 1). In some embodiments, the GNSS receiver 208 may be integrated into industrial or commercial equipment, such as survey equipment, Internet of Things (IoT) devices, etc.

It will be understood that the diagram provided in FIG. 2 is greatly simplified. In practice, there may be dozens of satellites 210 and a given GNSS constellation, and there are many different types of GNSS systems. As noted, GNSS systems include GPS, Galileo, GLONASS, or BDS. Additional GNSS systems include, for example, Quasi-Zenith Satellite System (QZSS) over Japan, Indian Regional Navigational Satellite System (IRNSS) over India, etc. In addition to the basic positioning functionality later described, GNSS augmentation (e.g., a Satellite Based Augmentation System (SBAS)) may be used to provide higher accuracy. Such augmentation may be associated with or otherwise enabled for use with one or more global and/or regional navigation satellite systems, such as, e.g., Wide Area Augmentation System (WAAS), European Geostationary Navigation Overlay Service (EGNOS), Multi-functional Satellite Augmentation System (MSAS), and Geo Augmented Navigation system (GAGAN), and/or the like.

GNSS positioning is based on trilateration/multilateration, which is a method of determining position by measuring distances to points at known coordinates. In general, the determination of the position of a GNSS receiver 208 in three dimensions may rely on a determination of the distance between the GNSS receiver 208 and four or more satellites 210. As illustrated, 3D coordinates may be based on a coordinate system (e.g., Cartesian coordinates in format of X, Y and Z; geographic coordinates in format of latitude, longitude, and altitude; etc.) centered at the earth's center of mass. A distance between each satellite 210 and the GNSS receiver 208 may be determined using precise measurements made by the GNSS receiver 208 of a difference in time from when an RF signal is transmitted from the respective satellite 210 to when it is received at the GNSS receiver 208. To help ensure accuracy, not only does the GNSS receiver 208 need to make an accurate determination of when the respective signal from each satellite 210 is received, but many additional factors need to be considered and accounted for. These factors include, for example, clock differences at the GNSS receiver 208 and satellite 210 (e.g., clock bias), a precise location of each satellite 210 at the time of transmission (e.g., as determined by the broadcast ephemeris), the impact of atmospheric distortion (e.g., ionospheric and tropospheric delays), and the like.

To perform a traditional GNSS position fix, the GNSS receiver 208 can use code-based positioning to determine its distance to each satellite 210 based on a determined delay in a generated pseudorandom binary sequence received in the RF signals received from each satellite, in consideration of the additional factors and error sources previously noted. Code-based positioning measurements for positioning in this manner may be referred to as pseudo-range (or PR) measurements. With the distance and location information of the satellites 210, the GNSS receiver 208 can then determine a position fix for its location. This position fix may be determined, for example, by a Standalone Positioning Engine (SPE) executed by one or more processors of the GNSS receiver 208. However, code-based positioning is relatively inaccurate and, without error correction, and is subject to many of the previously described errors. Even so, code-based GNSS positioning can provide a positioning accuracy for the GNSS receiver 208 on the order of meters.

More accurate carrier-based ranging is based on a carrier wave of the RF signals received from each satellite and further uses error correction to help reduce errors from the previously noted error sources. Carrier-based positioning measurements for positioning in this manner may be referred to as carrier phase (or CP) measurements. Some techniques utilize differential error correction, in which errors (e.g., atmospheric errors sources) in the carrier-based ranging of satellites 210 observed by the GNSS receiver 208 can be mitigated or canceled based on similar carrier-based ranging of the satellites 210 using a highly accurate GNSS receiver at the base station at a known location. These measurements and the base station's location can be provided to the GNSS receiver 208 for error correction. This position fix may be determined, for example, by a Precise Positioning Engine (PPE) executed by one or more processors of the GNSS receiver 208. More specifically, in addition to the information provided to an SPE, the PPE may use base station GNSS measurement information, and additional correction information, such as troposphere and ionosphere, to provide a high-accuracy, carrier-based position fix. Several GNSS techniques can be adopted in PPE, such as Differential GNSS (DGNSS), Real-Time Kinematic (RTK), and Precise Point Positioning (PPP), and may provide a sub-meter accuracy (e.g., on the order of centimeters). (An SPE and/or PPE may be referred to herein as a GNSS positioning engine and may be incorporated into a broader positioning engine that uses other (non-GNSS) positioning sources.)

Multi-frequency GNSS receivers use satellite signals from different GNSS frequency bands (also referred to herein simply as “GNSS bands”) to determine desired information such as pseudoranges, position estimates, and/or time. Using multi-frequency GNSS may provide better performance (e.g., position estimate speed and/or accuracy) than single-frequency GNSS in many conditions. However, using multi-frequency GNSS typically uses more power than single-frequency GNSS, e.g., processing power and battery power (e.g., to power a processor (e.g., for determining measurements), baseband processing, and/or RF processing).

Referring again to FIG. 2, the satellites 210 may be members of a single satellite constellation, i.e., a group of satellites that are part of a GNSS system, e.g., controlled by a common entity such as a government, and orbiting in complementary orbits to facilitate determining positions of entities around the world. One or more of the satellites 210 may transmit multiple satellite signals in different GNSS frequency bands, such as L1, L2, and/or L5 frequency bands. The terms L1 band, L2 band, and L5 band are used herein because these terms are used for GPS to refer to respective ranges of frequencies. Various receiver configurations may be used to receive satellite signals. For example, a receiver may use separate receive chains for different frequency bands. As another example, a receiver may use a common receive chain for multiple frequency bands that are close in frequency, for example L2 and L5 bands. As another example, a receiver may use separate receive chains for different signals in the same band, for example GPS L1 and GLONASS L1 sub-bands. A single receiver may use a combination of two or more of these examples. These configurations are examples, and other configurations are possible.

Multiple satellite bands are allocated to satellite usage. These bands include the L-band, used for GNSS satellite communications, the C-band, used for communications satellites such as television broadcast satellites, the X-band, used by the military and for RADAR applications, and the Ku-band (primarily downlink communication and the Ka-band (primarily uplink communications), the Ku and Ka bands used for communications satellites. The L-band is defined by IEEE as the frequency range from 1 to 2 GHZ. The L-Band is utilized by the GNSS satellite constellations such as GPS, Galileo, GLONASS, and BDS, and is broken into various bands, including L1, L2, and L5. For location purposes, the L1 band has historically been used by commercial GNSS receivers. However, measuring GNSS signals across more than one band may provide for improved accuracy and availability.

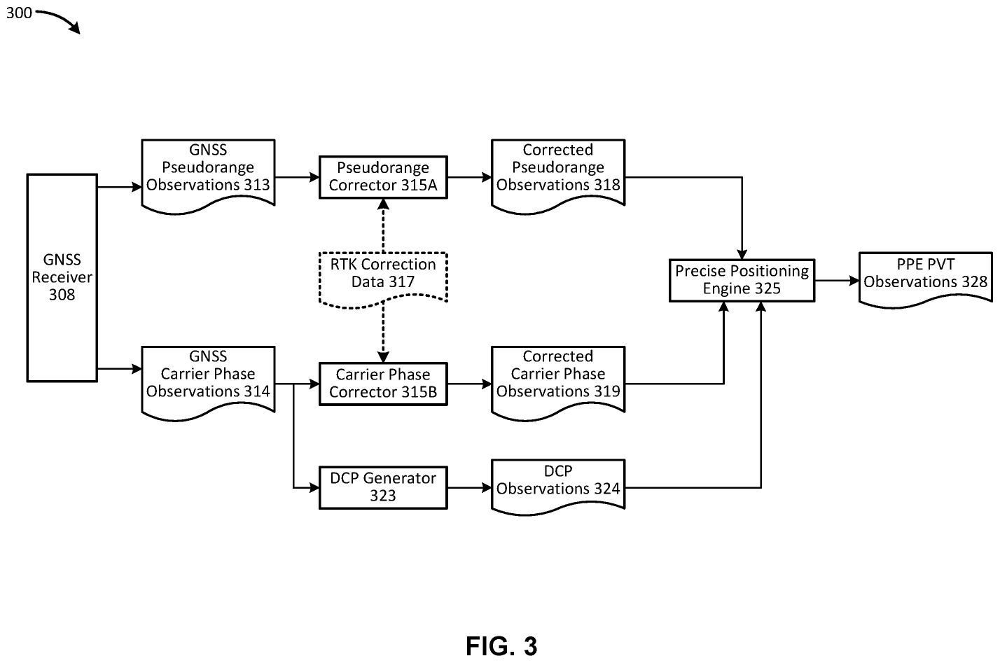

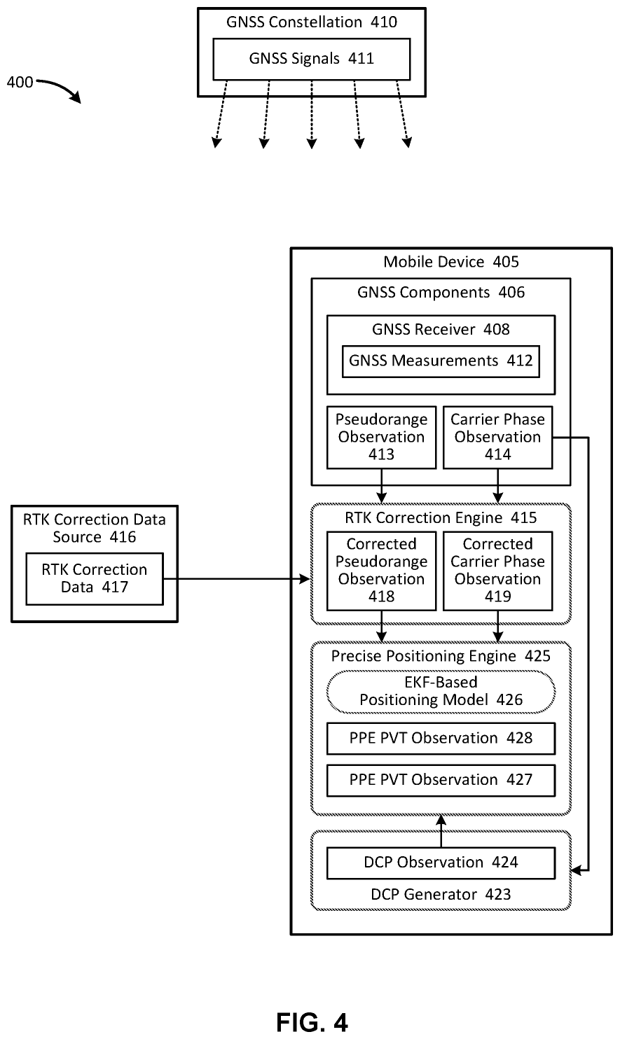

As previously noted, precise positioning (e.g., RTK or PPP positioning) may utilize error correction provided by an error correction service. FIGS. 3 and 4 illustrate how such correction may be utilized in RTK. A similar process may be used for PPP and/or other precise positioning techniques.

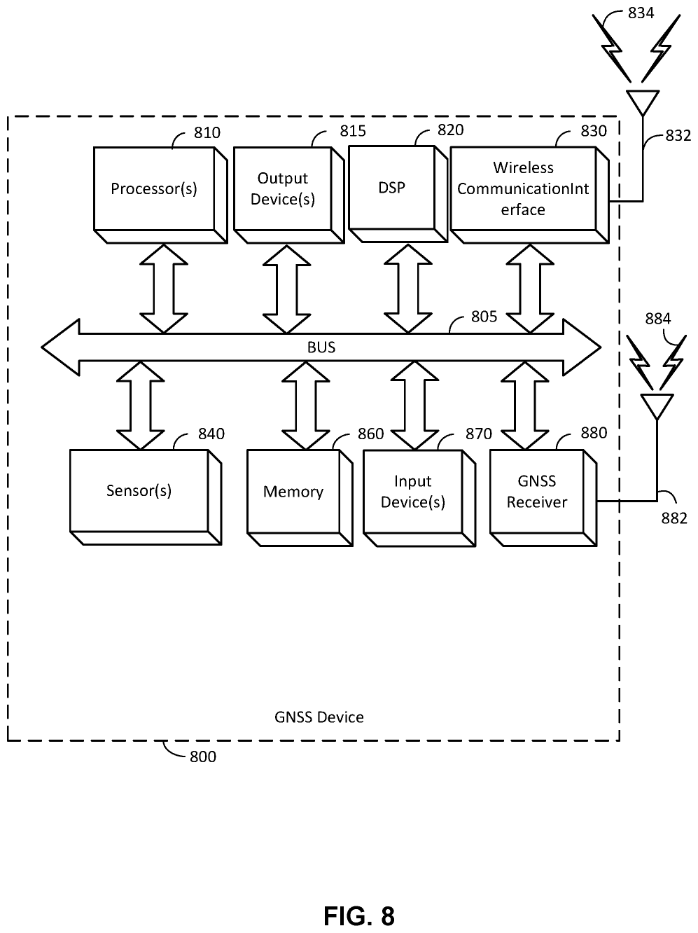

FIG. 3 is a block diagram illustrating an example positioning scheme 300, according to aspects of the disclosure. In some embodiments, the various blocks may be implemented by software and/or hardware components of a positioning engine, which may be integrated into the GNSS device for which positioning is determined. (Example components of a GNSS device are shown in FIG. 8, which is described in detail hereafter.) Positioning scheme 300 may be representative of an RTK-based positioning scheme capable of utilizing DCP-based measurement updates (also referred to herein simply as “DCP updates”). According to positioning scheme 300, a GNSS receiver 308 measures GNSS signals to obtain GNSS pseudorange observations 313 and GNSS carrier phase observations 314. In various examples, the GNSS receiver 308 may correspond to GNSS receiver 208 of FIG. 2 and/or may be incorporated into a mobile or other device (e.g., mobile device 105 of FIG. 1). Based on RTK correction data 317, a pseudorange corrector 315A corrects GNSS pseudorange observations 313 to obtain corrected pseudorange observations 318, and a carrier phase corrector 315B corrects GNSS carrier phase observations 314 to obtain corrected carrier phase observations 319. In various examples, the RTK correction data 317 may be representative of correction data provided by a correction service (e.g., RTK correction service). Based on corrected pseudorange observations 318 and corrected carrier phase observations 319, a precise positioning engine (PPE) 325 generates PPE position, velocity, and time (PVT) observations 328.

As noted the positioning scheme 300 can further utilize DCP updates when correction data is unavailable. That is, according to positioning scheme 300, a DCP generator 323 can generate DCP observations 324 based on the GNSS carrier phase observations 314 provided by the GNSS receiver 308. If RTK correction data 317 is unavailable, a precise positioning engine 325 may not have access to corrected pseudorange observations 318 and corrected carrier phase observations 319, but rather merely to GNSS pseudorange observations 313 and GNSS carrier phase observations 314. However, the DCP observations 324 may be highly accurate even if the GNSS carrier phase observations 314 are not, and the precise positioning engine 325 may be able to use highly-accurate relative positioning information embodied in the DCP observations 324 to generate highly-accurate PPE PVT observations 328. According to aspects of the disclosure, when RTK correction data 317 is available, the precise positioning engine 325 may use the highly-accurate relative positioning information embodied in the DCP observations 324 to enhance the accuracy of position estimation that it conducts based on the corrected pseudorange observations 318 and the corrected carrier phase observations 319.

FIG. 4 is a block diagram illustrating an example operating environment 400 in which mobile device 405 may implement techniques for precise positioning using DCP-based measurement updates according to aspects of the disclosure. For instance, in some examples, mobile device 405 may implement positioning scheme 300 of FIG. 3 in operating environment 400 of FIG. 4. In some embodiments, the various components of the mobile device 405 as illustrated in FIG. 4 may be implemented by software and/or hardware components of the mobile device. (Again, example components of a GNSS device, which may comprise or be incorporated into a mobile device, are shown in FIG. 8, which is described in detail hereafter.) In operating environment 400, mobile device 405 can obtain a positioning estimate (in the form of a PPE PVT observation 428 for a positioning epoch Ej) from a precise positioning engine 425 that applies an extended Kalman filter (EKF)-based positioning model 426 to implement the positioning scheme 300 of FIG. 3.

As shown in FIG. 4, the GNSS receiver 408 of mobile device 405 can measure received GNSS signals 411 of a GNSS constellation 410 to obtain GNSS measurements 412. In some examples, the GNSS constellation 410 can be a BeiDou Navigation Satellite System (BDS) constellation. In some other examples, the GNSS constellation 410 can be a Galileo constellation. In yet other examples, the GNSS constellation 410 can be a GPS constellation or a GLONASS constellation. Based on the GNSS measurements 412, the GNSS components 406 can generate, for the positioning epoch Ej, a pseudorange observation 413 and a carrier phase observation 414. In various examples, the pseudorange observation 413 and the carrier phase observation 414 can correspond to respective ones of the pseudorange observations 413 and the carrier phase observations 414 of the positioning scheme 300 of FIG. 3.

In operating environment 400, if RTK correction data 417 associated with the GNSS constellation 410 is available, the RTK correction engine 415 may be able to correct pseudorange observation 413 and carrier phase observation 414 based on the RTK correction data 417, to obtain corrected pseudorange observation 418 and corrected carrier phase observation 419, respectively. In various examples, the RTK correction data 417 can correspond to the RTK correction data 417 of the positioning scheme 300 of FIG. 3, and the corrected pseudorange observation 418 and the corrected carrier phase observation 419 can correspond to respective ones of the corrected pseudorange observations 418 and the corrected carrier phase observations 419 of the positioning scheme 300 of FIG. 3.

According to aspects of the disclosure, in operating environment 400, mobile device 405 can execute a precise positioning engine (PPE) 425. As illustrated, according to some embodiments, a precise positioning engine 425 can implement an extended Kalman filter (EKF)-based positioning model 426.

In operating environment 400, if RTK correction data 417 is available, and thus RTK correction engine 415 can provide precise positioning engine 425 with the corrected pseudorange observation 418 and the corrected carrier phase observation 419, then precise positioning engine 425 can generate the PPE PVT observation 428 for a positioning epoch based on the corrected pseudorange observation 418 and the corrected carrier phase observation 419. However, if RTK correction data 417 is not available, precise positioning engine 425 may not be provided with the corrected pseudorange observation 418 and the corrected carrier phase observation 419, and may thus not be able to use them to generate the PPE PVT observation 428 for the positioning epoch.

If RTK correction data associated with a given GNSS constellation is not available, the precise positioning engine 425 can use DCP observations associated with that constellation to generate accurate PPE PVT observations. In the example depicted in FIG. 4, if RTK correction data 417 associated with GNSS constellation 410 is not available, the precise positioning engine 425 can use a DCP observation 424 associated with the GNSS constellation 410 to generate an accurate PPE PVT observation 428 for a positioning epoch and may continue to do so for successive positioning epochs until RTK correction data 417 is again available. As shown in FIG. 4, the mobile device 405 can execute a DCP generator 423, which can generate the DCP observation 424 based on carrier phase observation 414. The precise positioning engine 425 can generate the PPE PVT observation 428 for a given positioning epoch based on the DCP observation 424 and a PPE PVT observation 427 for a preceding positioning epoch. In some examples, the precise positioning engine 425 can make use of the DCP observation 424 in generating the PPE PVT observation 428 even if the RTK correction data 417 associated with the GNSS constellation 410 is available. For instance, in some examples, the precise positioning engine 425 may generate the PPE PVT observation 428 for a given positioning epoch based on corrected pseudorange observation 418, corrected carrier phase observation 419, the PPE PVT observation 427 for the preceding positioning epoch, and the DCP observation 424.

The utilization of DCP can enable a positioning engine of a device to continue to provide a high-accuracy positioning solution for the device after losing RTK correction information as described above, or, in other embodiments, other types of error correction data (e.g., PPP data). Although errors may be negligible over a short period of time, they can accumulate, causing positioning accuracy to deteriorate over time. This is especially the case for error due to ionosphere delay (also referred to herein as “ionosphere error” or “ionosphere error”).

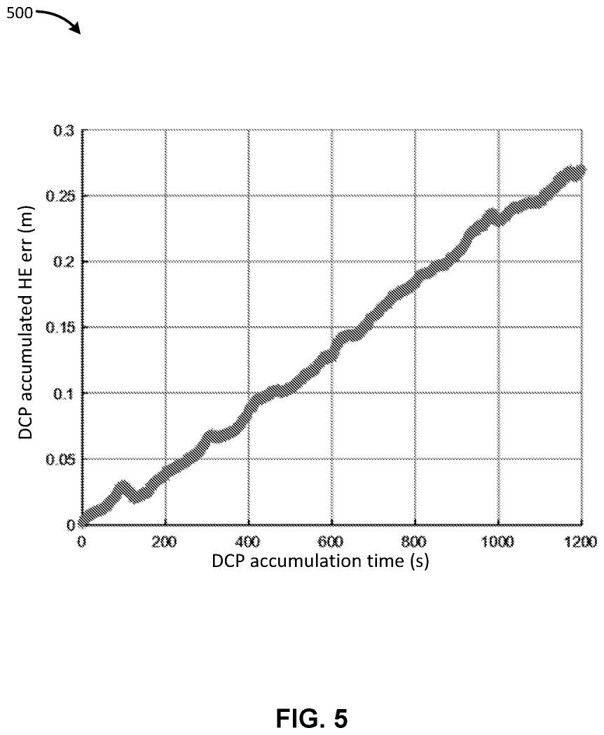

FIG. 5 is a diagram 500 that plots DCP accumulated horizontal error (HE) (in meters) over time (in seconds), for an example set of GNSS measurements. As can be seen, DCP accumulated HE error may be relatively small for a period of time. Depending on the application, this error can be negligible up to a point. However, the accumulation of error over time can cause issues in certain applications. For example, the accumulation of He error may exceed 30 cm over the course of 20 minutes, which may cause issues in automated driving and other applications. A large part of the DCP accumulated error comprises ionospheric error. As such, some instances may have even more error than what is shown in diagram 500, depending on device location and ionospheric activity.

According to aspects of the embodiments described herein, ionosphere error can be calculated and compensated for, to help keep HE error low, even after a relatively long period of time. In brief, embodiments can utilize a delta-ionosphere correction determination that takes a geometry-free approach to computing the delta-ionosphere delay correction accurately. Depending on desired functionality, the delta ionosphere correction can be precisely determined from various sources. In some embodiments, the device for which the estimated position is determined may determine the delta-ionosphere correction based on multi-band measurements it makes. Additionally or alternatively, other devices, such as nearby devices or base stations, may determine the delta-ionosphere correction. In such embodiments, there may be no requirement for device position accuracy or frequency band matching between the nearby device and the device receiving the delta-ionosphere correction. In some embodiments, a multi-band device may share measurement information with a single-band device. Further, embodiments not only may use delta-ionosphere correction for a DCP update, but embodiments may additionally or alternatively use delta-ionosphere correction with other types of information for GNSS-based positioning, such as SBAS and/or SSR PPE information. Additional details are provided below.

According to embodiments, the determination of delta-ionosphere correction may begin with a dual-band carrier phase measurement of a satellite, which may be represented mathematically as follows:

$${Φ}_{Li} = ρ + dT + δ Orb + δ Clk + {ISTB}_{Li} + dTrop - \frac{{f}_{1}^{2} * dIono}{{f}_{i}^{2}} + {λ}_{Li} ( {N}_{Li} + {r}_{Li} - {s}_{Li} ) + {ϵ}_{{Φ}_{Li}} , and \qquad ( Eqn . 1 )$$

$${Φ}_{Lj} = ρ + dT + δ Orb + δ Clk + {ISTB}_{Lj} + dTrop - \frac{{f}_{1}^{2} * dIono}{{f}_{j}^{2}} + {λ}_{Lj} ( {N}_{Lj} + {r}_{Lj} - {s}_{Lj} ) + {ϵ}_{{Φ}_{Lj}} , \qquad ( Eqn . 2 )$$

where Φ in Eqn. 1 and Eqn. 2 is a carrier phase measurement (e.g., in meters (m)) for respective frequency bands Li and Lj (where L* indicates the signal band, e.g., L1, L2, L5, etc. for band-specific terms) used by the satellite to transmit GNSS signals, ρ is geometry range (m), dT is receiver clock (m), δOrb is satellite orbit error (m), δClk is satellite clock error (m), ISTB is inter/intra system/signal time biases (m), dTrop is the troposphere delay residual error (after applying the troposphere model) (m), dlono is the ionosphere delay residual error on L1 band after applying the model (m), f is the central frequency of specified signal band (e.g., in Hz), λ is the wavelength (m), N is the ambiguity integer term (e.g., in cycles), r is the ambiguity receiver fractional bias term (cycle), s is the ambiguity satellite fractional bias term (cycle) and ∈ is noise and multipath (m).

According to embodiments, a geometry-free carrier phase measurement may then be obtained by using Eqn. 1 and Eqn. 2 to take a difference in carrier phase measurements. Common terms in Eqn. 1 and Eqn. 2 (ρ, dT, δOrb, δClk, and dTrop) cancel out, leaving the following:

$$\begin{matrix}{Φ}_{Li} - {Φ}_{Lj} = ( {ISTB}_{Li} - {ISTB}_{Lj} ) - ( \frac{{f}_{1}^{2} * dIono}{{f}_{i}^{2}} - \frac{{f}_{1}^{2} * dIono}{{f}_{j}^{2}} ) + [ {λ}_{Li} ( {N}_{Li} + {r}_{Li} - {s}_{Li} ) - {λ}_{Lj} ( {N}_{Lj} + {r}_{Lj} - {s}_{Lj} ) ] \\ = ( {ISTB}_{Li} - {ISTB}_{Lj} ) + \frac{{f}_{i}^{2} - {f}_{j}^{2}}{{f}_{i}^{2} {f}_{j}^{2}} * {f}_{1}^{2} * dIono + [ {λ}_{Li} ( {N}_{Li} + {r}_{Li} - {s}_{Li} ) - {λ}_{Lj} ( {N}_{Lj} + {r}_{Lj} - {s}_{Lj} ) ] ,\end{matrix} \qquad ( Eqn . 3 )$$

Additional terms may be canceled by taking measurements (Eqn. 1 and 2) at a subsequent epoch, then taking a difference between geometry-free carrier phase measurements (Eqn. 3) of both epochs to cancel out terms that do not (substantially) change over time. For measurements at a first epoch, tn, and a second epoch, tm, the difference in respective geometry-free carrier phase measurements results in the canceling out of ISTB, N, r, and s terms, leaving the following equation:

$${( {Φ}_{Li} - {Φ}_{Lj} )}_{tn} - {( {Φ}_{Li} - {Φ}_{Lj} )}_{tm} = {( \frac{{f}_{i}^{2} - {f}_{j}^{2}}{{f}_{i}^{2} {f}_{j}^{2}} * {f}_{1}^{2} * dIono )}_{tn} + {( \frac{{f}_{i}^{2} - {f}_{j}^{2}}{{f}_{i}^{2} {f}_{j}^{2}} * {f}_{1}^{2} * dIono )}_{tm} \qquad ( Eqn . 4 )$$

It can be noted that ambiguity may change between epochs. But where ambiguity is tracked, it is a known value. Thus, if there is no cycle slip between epochs, it can be canceled out.

Eqn. 4 may then be used to calculate a change in the ionosphere error term, dlono, over time. Solving for the change in dlono between tn and tm results in the following equation:

$$[ ] = [ \frac{{( {Φ}_{Li} - {Φ}_{Lj} )}_{tn} - {( {Φ}_{Li} - {Φ}_{Lj} )}_{tm}}{\frac{{f}_{i}^{2} - {f}_{j}^{2}}{{f}_{i}^{2} {f}_{j}^{2}} * {f}_{1}^{2}} ] . \qquad ( Eqn . 5 )$$

For a given band Li, the dlono correction for the change in dlono between tn and tm may then be applied to a DCP update:

$${( {Φ}_{Li , tn} - {Φ}_{Lj , tm} )}_{corrected} = ( {Φ}_{Li , tn} - {Φ}_{Lj , tm} ) + \frac{{f}_{1}^{2} * [ ]}{{f}_{i}^{2}} . \qquad ( Eqn . 6 )$$

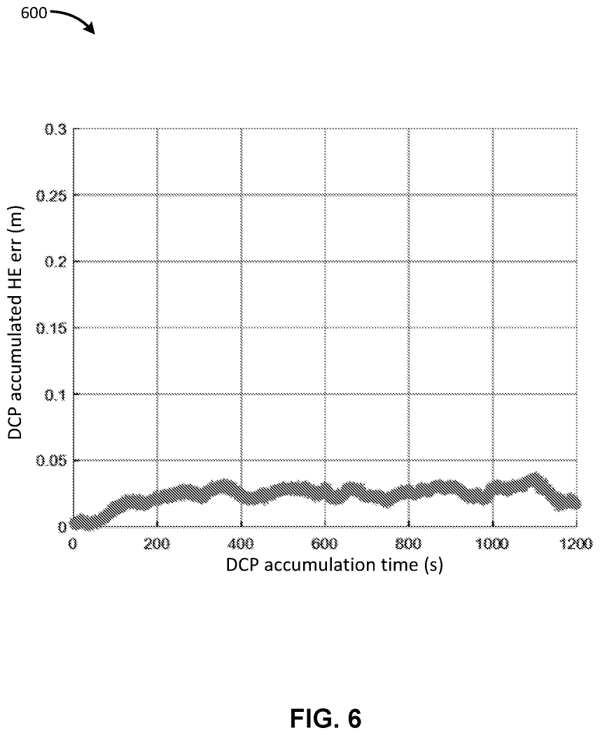

The application of the above-described process (e.g., with respect to Eqn. 1-6) can help remove the accumulation of ionosphere error, which can significantly reduce DCP update accumulated HE. As an example, FIG. 6 is a diagram 600 that plots DCP accumulated HE using the same underlying GNSS data as used in the diagram 500 of FIG. 5. In the diagram 600, however, dlono correction was calculated and applied in the manner above, resulting in a significant reduction in DCP update accumulated HE. After 20 minutes, the DCP update accumulated HE remains below 5 cm.

It can be noted that the above-described techniques for determining dlono correction may not only be utilized to correct DCP update information but may be used in additional or alternative applications. One such application is state space representation (SSR) information for PPE positioning solutions, or “SSR PPE,” that otherwise does not have ionosphere estimation.

SSR comprises information utilized by a PPE for error correction in determining a high-precision position. In many cases, SSR may not include ionosphere estimation data. However, because ionosphere is one of the major error sources to be handled for SSR PPE, a typical solution for SSR PPE is to either perform ionosphere-free measurement, or to introduce an additional EKF state who estimate ionosphere error. But performing an ionosphere-free measurement can degrade performance by amplifying multipath and noise. And introducing a new EKF state can ultimately result in a longer convergence time for the PPE and introduce complexity to select the proper initialization/time update model for the added ionosphere EKF state.

The address these and/or other issues, embodiments may use the delta ionosphere correction, derived above, for SSR PPE estimation. This can ultimately allow for a time invariant ionosphere term that does not need a separate EKF state. For example, a traditional SSR PPE solution may utilize the following equation:

$${Φ}_{Li , tm} = ρ + dT + {ISTB}_{Li} + dTrop - \frac{{f}_{1}^{2} * dIon {o}_{t m}}{{f}_{i}^{2}} + {λ}_{Li} ( {N}_{Li} + {r}_{Li} - {s}_{Li} ) + {ϵ}_{{Φ}_{Li}} , \qquad ( Eqn . 7 )$$

where the ionosphere term

$$\frac{{f}_{1}^{2} * dIon {o}_{t m}}{{f}_{i}^{2}}$$

is time variant (and therefore requires an additional EKF state), and the ambiguity term Δ_{Li}(N_{Li}+r_{Li}−s_{Li}) is time invariant.

However, according to some embodiments, an SSR PPE may utilize dlono correction as derived above (shown in Eqn. 5). In so doing, the SSR PPE may modify Eqn. 7 as follows:

$${Φ}_{Li , tm} = ρ + dT + {ISTB}_{Li} + dTrop - \frac{{f}_{1}^{2} * ( )}{{f}_{i}^{2}} - [ \frac{{f}_{1}^{2} * {dIono}_{tn}}{{f}_{i}^{2}} + {λ}_{Li} ( {N}_{Li} + {r}_{Li} - {s}_{Li} ) ] + {ϵ}_{{Φ}_{Li}} , \qquad ( Eqn . 8 )$$

Here, the ionosphere term

$$\frac{{f}_{1}^{2} * ( )}{{f}_{i}^{2}}$$

is known from Eqn. 5, and the term

$$\frac{{f}_{1}^{2} * {dIono}_{t n}}{{f}_{i}^{2}}$$

is time invariant, so ionosphere does not need a new EKF state. The time-invariant ionosphere error may be estimated together with the time-invariant ambiguity term. Thus, by introducing the dlono correction from Eqn. 5 into an SSR PPE solution, it can avoid both the amplified multipath and noise of an ionosphere-free solution and the additional convergence time and complexity of introducing a new EKF state.

Another application which dlono correction may be used is for SBAS to reduce ionosphere correction latency. SBAS is an augmentation to traditional GNSS that was designed for aviation use and is available to others as a public service, provided by different government agencies (e.g., in the United States, Europe, China, India, etc.) using dedicated geo-stationary satellites. SBAS contains integrity information and differential correction (e.g., orbit, clock, and ionosphere) and is transmitted on the L1 band at 250 bps. The SBAS ionosphere information, which may have a correction accuracy of approximately half a meter, includes estimated ionosphere delay values on a 5° by 5° grid, updated every five minutes. This means, for a device receiving SBAS information, the latency of ionosphere correction may be up to five minutes. But the accumulated error over the course of five minutes may be unacceptable for certain applications.

By adopting using the dlono correction as described herein, a device can mitigate the ionosphere impact by reducing SBAS ionosphere correction latency. More specifically, upon receiving SBAS with ionosphere grid correction values for a given time, the receiving device may apply dlono correction to account for changes in the ionosphere error between the given time and a current time. For example, if the receiving device receives the information at time t299 for ionosphere correction grid values applicable at t0, the receiving device may determine the dlono correction between t0 and t299 using Eqn. 5 and apply it to the received SBAS ionosphere correction (e.g., for the grid point or ionospheric pierce point (IPP) applicable to a satellite to which the SBAS information applies) to account for changes in the ionosphere error between t0 and t299. Without this correction, a device receiving SBAS ionosphere correction would either have to perform some other form correction, or deal with did the degraded performance of using ionosphere delay values that no longer may be applicable to the current time.

Another application which the dlono correction of Eqn. 5 may be used is for DCP updates for a single band (SB) satellite. As described with respect to Eqn. 1-5 above, dlono correction can be determined for a multiband (MB) satellite by measurements by aanMB receiver of two frequency bands (Li and Lj) transmitted by an MB satellite. Eqn. 6 further illustrates how this dlono correction may be applied for DCP updates applicable to measurements of signals transmitted by the MB satellite in the two frequency bands. However, embodiments are not so limited.

The dlono correction additionally or alternatively may be used to determine DCP updates for a single band. More specifically, DCP updates (MB or SB) may be calculated as the sum of a change (delta) in (1) geometry, (2) clock, (3) ionosphere, and (4) troposphere delays. Because the change in (4) troposphere delay is typically very small, it can be ignored. Further, the change in (3) ionosphere (MB dlono correction) may be determined from MB measurements (as described above). Thus, the sum of (1) delta geometry and (2) delta clock may be determined as the difference between MB DCP and MB dlono correction. SB dlono correction may then be determined by subtracting the sum of delta geometry and delta clock from MB DCP. Thus, embodiments for determining and applying dlono correction as described herein may be extended to SB use cases. For example, a first device comprising an MB GNSS receiver may determine the sum of delta geometry and delta clock, as well as the MB DCP and/or MB dlono correction. The first device may then share these terms with a second device comprising an SB GNSS receiver, which may then determine SB dlono correction and corresponding SB DCP updates to apply dlono correction to a single band.

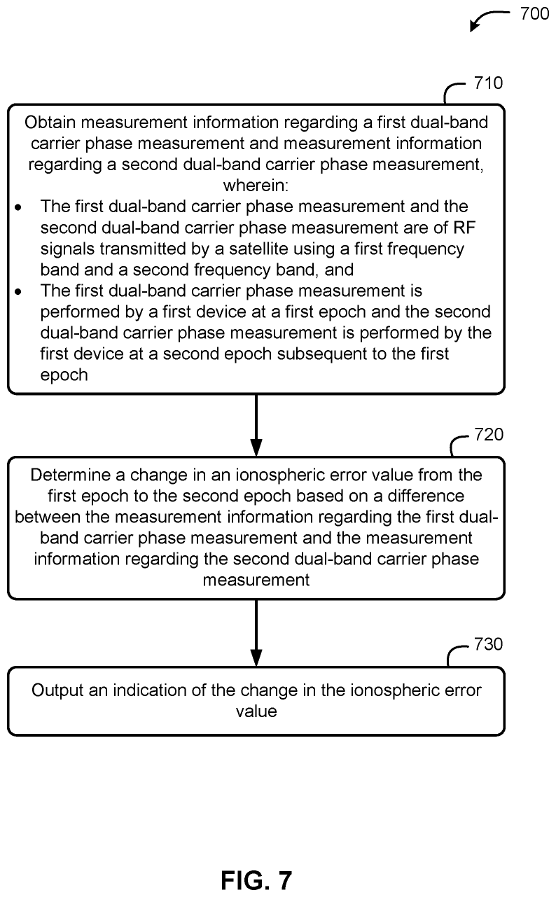

FIG. 7 is a flow diagram illustrating an example method 700 of enabling ionospheric error compensation in GNSS-based positioning, according to aspects of the disclosure. According to aspects of the disclosure, means for performing the functionality illustrated in one or more of the blocks shown in FIG. 7 may be performed by hardware and/or software components of a GNSS device, which may comprise a mobile device, base station, or other device comprising and/or communicatively coupled with a GNSS receiver. Example components of a GNSS device are illustrated in FIG. 8, which is described in more detail below. In some examples, mobile device 405 (e.g., using components shown in FIG. 8) may perform the functionality illustrated in one or more of the blocks shown in FIG. 7 in operating environment 400 of FIG. 4.

At block 710, the functionality comprises obtaining measurement information regarding a first dual-band carrier phase measurement and measurement information regarding a second dual-band carrier phase measurement, wherein: the first dual-band carrier phase measurement and the second dual-band carrier phase measurement are of RF signals transmitted by a satellite using a first frequency band and a second frequency band, and the first dual-band carrier phase measurement is performed by a first device at a first epoch and the second dual-band carrier phase measurement is performed by the first device at a second epoch subsequent to the first epoch. This functionality may, for example, correspond with the functionality described above with respect to obtaining measurements (e.g., Eqn. 1-2) at two different epochs.

Means for performing functionality at block 710 may comprise a bus 805, processor(s) 810, digital signal processor (DSP) 820, memory 860, GNSS receiver 880, and/or other components of a GNSS device 800, as illustrated in FIG. 8.

At block 720, the functionality comprises determining a change in an ionospheric error value from the first epoch to the second epoch based on a difference between the measurement information regarding the first dual-band carrier phase measurement and the measurement information regarding the second dual-band carrier phase measurement. This functionality may comprise performing the operations associated with Eqn. 3-5 described herein.

Means for performing functionality at block 720 may comprise a bus 805, processor(s) 810, digital signal processor (DSP) 820, memory 860, GNSS receiver 880, and/or other components of a GNSS device 800, as illustrated in FIG. 8.

At block 730, the functionality comprises outputting an indication of the change in the ionospheric error value. As described herein, an indication of the change in an ionospheric error value may be used in any of a variety of ways, depending on desired functionality. For example, outputting the indication of the change in the ionospheric error value may comprise providing the change in the ionospheric error value, a determined position of the first device based at least in part on the change in the ionospheric error value, or both, to a positioning engine of the first device, a processor of the first device, an application executed by the first device, a user interface of the first device, a second device, or any combination thereof. In some embodiments, the second device may be within a threshold distance of the first device. This can help ensure a similar change in ionospheric error value. According to some embodiments, the indication of the change in the ionospheric error value may be provided by a first device (e.g., an MB GNSS receiver) to a second device (e.g., an SB GNSS receiver) to enable the second device to perform single-band ionospheric error correction. In such embodiments, outputting the indication of the change in the ionospheric error value may comprise sending the change in the ionospheric error value and a sum of delta geometry and delta clock values to a second device for determination of a change in the ionospheric error value with respect to a single GNSS frequency band. In some embodiments, outputting the indication of the change in the ionospheric error value may comprise including the information indicative of the change in the ionospheric error value in a DCP update.

Means for performing functionality at block 730 may comprise a bus 805, processor(s) 810, digital signal processor (DSP) 820, memory 860, GNSS receiver 880, and/or other components of a GNSS device 800, as illustrated in FIG. 8.

As indicated herein, variations to the method 700 may include additional or alternative features, depending on desired functionality. In some embodiments, for example, outputting the indication of the change in the ionospheric error value may comprise including information indicative of the change in the ionospheric error value in SSR data for positioning by a PPE. Additionally or alternatively, outputting the indication of the change in the ionospheric error value may comprise outputting a determined position of the first device, wherein the determined position is based at least in part on the ionospheric error value and SBAS information received by the first device. This determination may be performed, for example, as described herein with regard to the application of SBAS information. According to some embodiments, the first dual-band carrier phase measurement and the second dual-band carrier phase measurement may, each have a known integer ambiguity term, and determining the change in an ionospheric error value may comprise determining that there is no cycle slip between the first dual-band carrier phase measurement and the second dual-band carrier phase measurement. As described herein, ensuring a known value for the ambiguity term can enable the mathematical determination of the change in the ionospheric error value.

FIG. 8 is a block diagram of an embodiment of a GNSS device 800, which can be utilized as described herein above (e.g., in association with FIGS. 1-7). For example, the GNSS device 800 can be used to implement one or more of mobile device 105 of FIG. 1, mobile device 405 of FIG. 5, GNSS receiver 208, GNSS receiver 308, and/or RTK correction data source 416. In some examples, GNSS device 800 can perform one or more operations associated with one or more of positioning scheme 300 of FIG. 3, and/or method 700 of FIG. 7. It should be noted that FIG. 8 is meant only to provide a generalized illustration of various components, any or all of which may be utilized as appropriate. It can be noted that, in some instances, components illustrated by FIG. 8 can be localized to a single physical device and/or distributed among various networked devices, which may be disposed at different physical locations. Furthermore, as previously noted, the functionality of the UE discussed in the previously described embodiments may be executed by one or more of the hardware and/or software components illustrated in FIG. 8.

The GNSS device 800 is shown comprising hardware elements that can be electrically coupled via a bus 805 (or may otherwise be in communication, as appropriate). The hardware elements may include a processor(s) 810 which can include without limitation one or more general-purpose processors (e.g., an application processor), one or more special-purpose processors (such as digital signal processor (DSP) chips, graphics acceleration processors, application specific integrated circuits (ASICs), and/or the like), and/or other processing structures or means. Processor(s) 810 may comprise one or more processing units, which may be housed in a single integrated circuit (IC) or multiple ICs. As shown in FIG. 8, some embodiments may have a separate DSP 820, depending on desired functionality. Location determination and/or other determinations based on wireless communication may be provided in the processor(s) 810 and/or wireless communication interface 830 (discussed below). The GNSS device 800 also can include one or more input devices 870, which can include without limitation one or more keyboards, touch screens, touch pads, microphones, buttons, dials, switches, and/or the like; and one or more output devices 815, which can include without limitation one or more displays (e.g., touch screens), light emitting diodes (LEDs), speakers, and/or the like.

The GNSS device 800 may also include a wireless communication interface 830, which may comprise without limitation a modem, a network card, an infrared communication device, a wireless communication device, and/or a chipset (such as a Bluetooth® device, an IEEE 802.11 device, an IEEE 802.15.4 device, a Wi-Fi device, a WiMAX device, a WAN device, and/or various cellular devices, etc.), and/or the like, which may enable the GNSS device 800 to communicate with other devices as described in the embodiments above. The wireless communication interface 830 may permit data and signaling to be communicated (e.g., transmitted and received) with TRPs of a network, for example, via eNBs, gNBs, ng-cNBs, access points, various base stations and/or other access node types, and/or other network components, computer systems, and/or any other electronic devices communicatively coupled with TRPs, as described herein. The communication can be carried out via one or more wireless communication antenna(s) 832 that send and/or receive wireless signals 834. According to some embodiments, the wireless communication antenna(s) 832 may comprise a plurality of discrete antennas, antenna arrays, or any combination thereof. The antenna(s) 832 may be capable of transmitting and receiving wireless signals using beams (e.g., Tx beams and Rx beams). Beam formation may be performed using digital and/or analog beam formation techniques, with respective digital and/or analog circuitry. The wireless communication interface 830 may include such circuitry.

Depending on desired functionality, the wireless communication interface 830 may comprise a separate receiver and transmitter, or any combination of transceivers, transmitters, and/or receivers to communicate with base stations (e.g., ng-eNBs and gNBs) and other terrestrial transceivers, such as wireless devices and access points. The GNSS device 800 may communicate with different data networks that may comprise various network types. For example, a WWAN may be a CDMA network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a WiMAX (IEEE 802.16) network, and so on. A CDMA network may implement one or more RATs such as CDMA2000®, WCDMA, and so on. CDMA2000® includes IS-95, IS-2000 and/or IS-856 standards. A TDMA network may implement GSM, Digital Advanced Mobile Phone System (D-AMPS), or some other RAT. An OFDMA network may employ LTE, LTE Advanced, 5G NR, and so on. 5G NR, LTE, LTE Advanced, GSM, and WCDMA are described in documents from 3GPP. CDMA2000® is described in documents from a consortium named “3rd Generation Partnership Project 2” (3GPP2). 3GPP and 3GPP2 documents are publicly available. A wireless local area network (WLAN) may also be an IEEE 802.11x network, and a wireless personal area network (WPAN) may be a Bluetooth network, an IEEE 802.15x, or some other type of network. The techniques described herein may also be used for any combination of WWAN, WLAN and/or WPAN.

The GNSS device 800 can further include sensor(s) 840. Sensor(s) 840 may comprise, without limitation, one or more inertial sensors and/or other sensors (e.g., accelerometer(s), gyroscope(s), camera(s), magnetometer(s), altimeter(s), microphone(s), proximity sensor(s), light sensor(s), barometer(s), and the like), some of which may be used to obtain position-related measurements and/or other information.

Embodiments of the GNSS device 800 may also include a Global Navigation Satellite System (GNSS) receiver 880 capable of receiving signals 884 from one or more GNSS satellites using an antenna 882 (which could be the same as antenna 832). Positioning based on GNSS signal measurement can be utilized to complement and/or incorporate the techniques described herein. The GNSS receiver 880 can extract a position of the GNSS device 800, using conventional techniques, from GNSS satellites of a GNSS system, such as Global Positioning System (GPS), Galileo, GLONASS, Quasi-Zenith Satellite System (QZSS) over Japan, IRNSS over India, BeiDou Navigation Satellite System (BDS) over China, and/or the like. Moreover, the GNSS receiver 880 can be used with various augmentation systems (e.g., a Satellite Based Augmentation System (SBAS)) that may be associated with or otherwise enabled for use with one or more global and/or regional navigation satellite systems, such as, e.g., Wide Area Augmentation System (WAAS), European Geostationary Navigation Overlay Service (EGNOS), Multi-functional Satellite Augmentation System (MSAS), and Geo Augmented Navigation system (GAGAN), and/or the like.

It can be noted that, although GNSS receiver 880 is illustrated in FIG. 8 as a distinct component, embodiments are not so limited. As used herein, the term “GNSS receiver” may comprise hardware and/or software components configured to obtain GNSS measurements (measurements from GNSS satellites). In some embodiments, therefore, the GNSS receiver may comprise a measurement engine executed (as software) by one or more processors, such as processor(s) 810, DSP 820, and/or a processor within the wireless communication interface 830 (e.g., in a modem). A GNSS receiver may optionally also include a positioning engine, which can use GNSS measurements from the measurement engine to determine a position of the GNSS receiver using an Extended Kalman Filter (EKF), Weighted Least Squares (WLS), particle filter, or the like. The positioning engine may also be executed by one or more processors, such as processor(s) 810 or DSP 820.

The GNSS device 800 may further include and/or be in communication with a memory 860. The memory 860 can include, without limitation, local and/or network accessible storage, a disk drive, a drive array, an optical storage device, a solid-state storage device, such as a random access memory (RAM), and/or a read-only memory (ROM), which can be programmable, flash-updateable, and/or the like. Such storage devices may be configured to implement any appropriate data stores, including without limitation, various file systems, database structures, and/or the like.

The memory 860 of the GNSS device 800 also can comprise software elements (not shown in FIG. 8), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the method(s) discussed above may be implemented as code and/or instructions in memory 860 that are executable by the GNSS device 800 (and/or processor(s) 810 or DSP 820 within GNSS device 800). In some embodiments, then, such code and/or instructions can be used to configure and/or adapt a general-purpose computer (or other device) to perform one or more operations in accordance with the described methods.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium” as used herein, refer to any storage medium that participates in providing data that causes a machine to operate in a specific fashion. In embodiments provided hereinabove, various machine-readable media might be involved in providing instructions/code to processors and/or other device(s) for execution. Additionally or alternatively, the machine-readable media might be used to store and/or carry such instructions/code. In many implementations, a computer-readable medium is a physical and/or tangible storage medium. Such a medium may take many forms, including but not limited to, non-volatile media and volatile media. Common forms of computer-readable media include, for example, magnetic and/or optical media, any other physical medium with patterns of holes, a RAM, a programmable ROM (PROM), crasable PROM (EPROM), a FLASH-EPROM, any other memory chip or cartridge, or any other medium from which a computer can read instructions and/or code.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus many of the elements are examples that do not limit the scope of the disclosure to those specific examples.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussion utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing device. In the context of this Specification, therefore, a special-purpose computer or a similar special-purpose electronic computing device is capable of manipulating or transforming signals, typically represented as physical electronic, electrical, or magnetic quantities within memories, registers, or other information storage devices, transmission devices, or display devices of the special purpose computer or similar special purpose electronic computing device.

Terms, “and” and “or” as used herein, may include a variety of meanings that also is expected to depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AA, AAB, AABBCCC, etc.

Having described several embodiments, various modifications, alternative constructions, and equivalents may be used without departing from the scope of the disclosure. For example, the above elements may merely be a component of a larger system, wherein other rules may take precedence over or otherwise modify the application of the various embodiments. Also, a number of steps may be undertaken before, during, or after the above elements are considered. Accordingly, the above description does not limit the scope of the disclosure.

In view of this description embodiments may include different combinations of features. Implementation examples are described in the following numbered clauses:
Clause 1: A method of enabling ionospheric error compensation in global navigation satellite system (GNSS)-based positioning, the method comprising: obtaining measurement information regarding a first dual-band carrier phase measurement and measurement information regarding a second dual-band carrier phase measurement, wherein: the first dual-band carrier phase measurement and the second dual-band carrier phase measurement are of radio frequency (RF) signals transmitted by a satellite using a first frequency band and a second frequency band, and the first dual-band carrier phase measurement is performed by a first device at a first epoch and the second dual-band carrier phase measurement is performed by the first device at a second epoch subsequent to the first epoch; determining a change in an ionospheric error value from the first epoch to the second epoch based on a difference between the measurement information regarding the first dual-band carrier phase measurement and the measurement information regarding the second dual-band carrier phase measurement; and outputting an indication of the change in the ionospheric error value.
Clause 2: The method of clause 1, wherein outputting the indication of the change in the ionospheric error value comprises including the information indicative of the change in the ionospheric error value in a differential carrier phase (DCP) update.
Clause 3: The method of any one of clauses 1-2 wherein outputting the indication of the change in the ionospheric error value comprises including information indicative of the change in the ionospheric error value in a State Space Representation (SSR) precise positioning engine (PPE) solution.
Clause 4: The method of clause 3 wherein including the information indicative of the change in the ionospheric error value the SSR PPE solution comprises: compensating a time-variant component of ionosphere error of the SSR PPE solution based on the change in the ionospheric error value; and estimating a time-invariant component of ionosphere error of the SSR PPE solution.
Clause 5: The method of clause 4 wherein estimating the time-invariant component of ionosphere error of the SSR PPE solution is performed using an extended Kalman filter state that also estimates an ambiguity term.
Clause 6: The method of any one of clauses 1-5 wherein outputting the indication of the change in the ionospheric error value comprises outputting a determined position of the first device, wherein the determined position is based at least in part on the ionospheric error value and Satellite-Based Augmentation System (SBAS) information received by the first device.
Clause 7: The method of any one of clauses 1-6 wherein the first dual-band carrier phase measurement and the second dual-band carrier phase measurement each have a known integer ambiguity term, and determining the change in the ionospheric error value comprises determining that there is no cycle slip between the first dual-band carrier phase measurement and the second dual-band carrier phase measurement.
Clause 8: The method of any one of clauses 1-7 wherein outputting the indication of the change in the ionospheric error value comprises providing the change in the ionospheric error value, a determined position of the first device based at least in part on the change in the ionospheric error value, or both, to: a positioning engine of the first device, a processor of the first device, an application executed by the first device, a user interface of the first device, a second device, or any combination thereof.
Clause 9: The method of clause 8 wherein the second device is within a threshold distance of the first device.
Clause 10: The method of any one of clauses 1-9 wherein outputting the indication of the change in the ionospheric error value comprises sending the change in the ionospheric error value and a sum of delta geometry and delta clock values to a second device for determination of a change in the ionospheric error value with respect to a single GNSS frequency band.
Clause 11: The method of any one of clauses 1-10 wherein outputting the indication of the change in the ionospheric error value comprises using the change in the ionospheric error value and a sum of delta geometry and delta clock values to determine a change in the ionospheric error value with respect to a single GNSS frequency band.
Clause 12: A global navigation satellite system (GNSS) device comprising: a GNSS receiver; one or more memories; and one or more processors communicatively coupled with the GNSS receiver and the one or more memories, wherein the one or more processors are configured to: obtain, via the GNSS receiver, measurement information regarding a first dual-band carrier phase measurement and measurement information regarding a second dual-band carrier phase measurement, wherein: the first dual-band carrier phase measurement and the second dual-band carrier phase measurement are of radio frequency (RF) signals transmitted by a satellite using a first frequency band and a second frequency band, and the first dual-band carrier phase measurement is performed by the GNSS device at a first epoch and the second dual-band carrier phase measurement is performed by the GNSS device at a second epoch subsequent to the first epoch; determine a change in an ionospheric error value from the first epoch to the second epoch based on a difference between the measurement information regarding the first dual-band carrier phase measurement and the measurement information regarding the second dual-band carrier phase measurement; and output an indication of the change in the ionospheric error value.
Clause 13: The device of clause 12, wherein, to output the indication of the change in the ionospheric error value, the one or more processors are configured to include the information indicative of the change in the ionospheric error value in a differential carrier phase (DCP) update.
Clause 14: The device of any one of clauses 12-13 wherein, to output the indication of the change in the ionospheric error value, the one or more processors are configured to include information indicative of the change in the ionospheric error value in a State Space Representation (SSR) precise positioning engine (PPE) solution.
Clause 15: The device of clause 14 wherein, to include the information indicative of the change in the ionospheric error value the SSR PPE solution, the one or more processors are configured to compensate a time-variant component of ionosphere error of the SSR PPE solution based on the change in the ionospheric error value; and estimate a time-invariant component of ionosphere error of the SSR PPE solution.
Clause 16: The device of clause 15 wherein the one or more processors are configured to estimate the time-invariant component of ionosphere error of the SSR PPE solution is using an extended Kalman filter state that also estimates an ambiguity term.
Clause 17: The device of any one of clauses 12-16 wherein the GNSS device comprises one or more transceivers, and wherein, to output the indication of the change in the ionospheric error value, the one or more processors are configured to output a determined position of the GNSS device, wherein the determined position is based at least in part on the ionospheric error value and Satellite-Based Augmentation System (SBAS) information received by the GNSS device via the one or more transceivers.
Clause 18: The device of any one of clauses 12-17 wherein, to determine the change in the ionospheric error value, the one or more processors are configured to determine that there is no cycle slip between the first dual-band carrier phase measurement and the second dual-band carrier phase measurement.
Clause 19: The device of any one of clauses 12-18 wherein the indication of the change in the ionospheric error value comprises providing the change in the ionospheric error value, a determined position of the GNSS device based at least in part on the change in the ionospheric error value, or both, to: a positioning engine of the GNSS device, a processor of the GNSS device, an application executed by the GNSS device, a user interface of the GNSS device, a second device via one or more transceivers of the GNSS device, or any combination thereof.
Clause 20: The device of clause 19 wherein the one or more processors are configured to determine the second device is within a threshold distance of the GNSS device.
Clause 21: The device of any one of clauses 12-20 wherein, to output the indication of the change in the ionospheric error value, the one or more processors are configured to send the change in the ionospheric error value and a sum of delta geometry and delta clock values to a second device for determination of a change in the ionospheric error value with respect to a single GNSS frequency band.
Clause 22: The device of any one of clauses 12-21 wherein, to output the indication of the change in the ionospheric error value, the one or more processors are configured to use the change in the ionospheric error value and a sum of delta geometry and delta clock values to determine a change in the ionospheric error value with respect to a single GNSS frequency band.
Clause 23: An apparatus for enabling ionospheric error compensation in global navigation satellite system (GNSS)-based positioning, the apparatus comprising: means for obtaining measurement information regarding a first dual-band carrier phase measurement and measurement information regarding a second dual-band carrier phase measurement, wherein: the first dual-band carrier phase measurement and the second dual-band carrier phase measurement are of radio frequency (RF) signals transmitted by a satellite using a first frequency band and a second frequency band, and the first dual-band carrier phase measurement is performed by a first device at a first epoch and the second dual-band carrier phase measurement is performed by the first device at a second epoch subsequent to the first epoch; means for determining a change in an ionospheric error value from the first epoch to the second epoch based on a difference between the measurement information regarding the first dual-band carrier phase measurement and the measurement information regarding the second dual-band carrier phase measurement; and means for outputting an indication of the change in the ionospheric error value.
Clause 24: The apparatus of clause 23, wherein the means for outputting the indication of the change in the ionospheric error value comprises means for including the information indicative of the change in the ionospheric error value in a differential carrier phase (DCP) update.
Clause 25: The apparatus of any one of clauses 23-24 wherein the means for outputting the indication of the change in the ionospheric error value comprises means for including information indicative of the change in the ionospheric error value in a State Space Representation (SSR) precise positioning engine (PPE) solution.
Clause 26: The apparatus of any one of clauses 23-25 wherein the means for outputting the indication of the change in the ionospheric error value comprises means for outputting a determined position of the first device, wherein the determined position is based at least in part on the ionospheric error value and Satellite-Based Augmentation System (SBAS) information received by the first device.
Clause 27: The apparatus of any one of clauses 23-26 further comprising means for determining that there is no cycle slip between the first dual-band carrier phase measurement and the second dual-band carrier phase measurement.
Clause 28: The apparatus of any one of clauses 23-27 wherein the means for outputting the indication of the change in the ionospheric error value comprises means for providing the change in the ionospheric error value, a determined position of the first device based at least in part on the change in the ionospheric error value, or both, to: a positioning engine of the first device, a processor of the first device, an application executed by the first device, a user interface of the first device, a second device, or any combination thereof.
Clause 29: The apparatus of any one of clauses 23-28 wherein the means for outputting the indication of the change in the ionospheric error value comprises means for sending the change in the ionospheric error value and a sum of delta geometry and delta clock values to a second device for determination of a change in the ionospheric error value with respect to a single GNSS frequency band.
Clause 30: A non-transitory computer-readable medium storing instructions for enabling ionospheric error compensation in global navigation satellite system (GNSS)-based positioning, the instructions comprising code for: obtaining measurement information regarding a first dual-band carrier phase measurement and measurement information regarding a second dual-band carrier phase measurement, wherein: the first dual-band carrier phase measurement and the second dual-band carrier phase measurement are of radio frequency (RF) signals transmitted by a satellite using a first frequency band and a second frequency band, and the first dual-band carrier phase measurement is performed by a first device at a first epoch and the second dual-band carrier phase measurement is performed by the first device at a second epoch subsequent to the first epoch; determining a change in an ionospheric error value from the first epoch to the second epoch based on a difference between the measurement information regarding the first dual-band carrier phase measurement and the measurement information regarding the second dual-band carrier phase measurement; and outputting an indication of the change in the ionospheric error value.
Clause 31: An apparatus having means for performing the method of any one of clauses 1-11.
Clause 32: A non-transitory computer-readable medium storing instructions, the instructions comprising code for performing the method of any one of clauses 1-11.

What is claimed is:

1. A method of enabling ionospheric error compensation in global navigation satellite system (GNSS)-based positioning, the method comprising:
obtaining measurement information regarding a first dual-band carrier phase measurement and measurement information regarding a second dual-band carrier phase measurement, wherein:
the first dual-band carrier phase measurement and the second dual-band carrier phase measurement are of radio frequency (RF) signals transmitted by a satellite using a first frequency band and a second frequency band, and
the first dual-band carrier phase measurement is performed by a first at a first epoch and the second dual-band carrier phase measurement is performed by the first device at a second epoch subsequent to the first epoch;
determining a change in an ionospheric error value from the first epoch to the second epoch based on a difference between the measurement information regarding the first dual-band carrier phase measurement and the measurement information regarding the second dual-band carrier phase measurement; and
outputting an indication of the change in the ionospheric error value.

2. The method of claim 1, wherein outputting the indication of the change in the ionospheric error value comprises including the information indicative of the change in the ionospheric error value in a differential carrier phase (DCP) update.

3. The method of claim 1, wherein outputting the indication of the change in the ionospheric error value comprises including information indicative of the change in the ionospheric error value in a State Space Representation (SSR) precise positioning engine (PPE) solution.

4. The method of claim 3, wherein including the information indicative of the change in the ionospheric error value the SSR PPE solution comprises:
compensating a time-variant component of ionosphere error of the SSR PPE solution based on the change in the ionospheric error value; and
estimating a time-invariant component of ionosphere error of the SSR PPE solution.

5. The method of claim 4, wherein estimating the time-invariant component of ionosphere error of the SSR PPE solution is performed using an extended Kalman filter state that also estimates an ambiguity term.

6. The method of claim 1, wherein outputting the indication of the change in the ionospheric error value comprises outputting a determined position of the first device, wherein the determined position is based at least in part on the ionospheric error value and Satellite-Based Augmentation System (SBAS) information received by the first device.

7. The method of claim 1, wherein the first dual-band carrier phase measurement and the second dual-band carrier phase measurement each have a known integer ambiguity term, and determining the change in the ionospheric error value comprises determining that there is no cycle slip between the first dual-band carrier phase measurement and the second dual-band carrier phase measurement.

8. The method of claim 1, wherein outputting the indication of the change in the ionospheric error value comprises providing the change in the ionospheric error value, a determined position of the first device based at least in part on the change in the ionospheric error value, or both, to:
a positioning engine of the first device,
a processor of the first device,
an application executed by the first device,
a user interface of the first device,
a second device, or
any combination thereof.

9. The method of claim 8, wherein the second device is within a threshold distance of the first device.

10. The method of claim 1, wherein outputting the indication of the change in the ionospheric error value comprises sending the change in the ionospheric error value and a sum of delta geometry and delta clock values to a second device for determination of a change in the ionospheric error value with respect to a single GNSS frequency band.

11. The method of claim 1, wherein outputting the indication of the change in the ionospheric error value comprises using the change in the ionospheric error value and a sum of delta geometry and delta clock values to determine a change in the ionospheric error value with respect to a single GNSS frequency band.

12. A global navigation satellite system (GNSS) device comprising:
a GNSS receiver;
one or more memories; and
one or more processors communicatively coupled with the GNSS receiver and the one or more memories, wherein the one or more processors are configured to:
obtain, via the GNSS receiver, measurement information regarding a first dual-band carrier phase measurement and measurement information regarding a second dual-band carrier phase measurement, wherein:
the first dual-band carrier phase measurement and the second dual-band carrier phase measurement are of radio frequency (RF) signals transmitted by a satellite using a first frequency band and a second frequency band, and
the first dual-band carrier phase measurement is performed by the GNSS device at a first epoch and the second dual-band carrier phase measurement is performed by the GNSS device at a second epoch subsequent to the first epoch;
determine a change in an ionospheric error value from the first epoch to the second epoch based on a difference between the measurement information regarding the first dual-band carrier phase measurement and the measurement information regarding the second dual-band carrier phase measurement; and
output an indication of the change in the ionospheric error value.

13. The device of claim 12, wherein, to output the indication of the change in the ionospheric error value, the one or more processors are configured to include the information indicative of the change in the ionospheric error value in a differential carrier phase (DCP) update.

14. The device of claim 12, wherein, to output the indication of the change in the ionospheric error value, the one or more processors are configured to include information indicative of the change in the ionospheric error value in a State Space Representation (SSR) precise positioning engine (PPE) solution.

15. The device of claim 14, wherein, to include the information indicative of the change in the ionospheric error value the SSR PPE solution, the one or more processors are configured to:
compensate a time-variant component of ionosphere error of the SSR PPE solution based on the change in the ionospheric error value; and
estimate a time-invariant component of ionosphere error of the SSR PPE solution.

16. The device of claim 15, wherein the one or more processors are configured to estimate the time-invariant component of ionosphere error of the SSR PPE solution is using an extended Kalman filter state that also estimates an ambiguity term.

17. The device of claim 12, wherein the GNSS device comprises one or more transceivers, and wherein, to output the indication of the change in the ionospheric error value, the one or more processors are configured to output a determined position of the GNSS device, wherein the determined position is based at least in part on the ionospheric error value and Satellite-Based Augmentation System (SBAS) information received by the GNSS device via the one or more transceivers.

18. The device of claim 12, wherein, to determine the change in the ionospheric error value, the one or more processors are configured to determine that there is no cycle slip between the first dual-band carrier phase measurement and the second dual-band carrier phase measurement.

19. The device of claim 12, wherein the indication of the change in the ionospheric error value comprises providing the change in the ionospheric error value, a determined position of the GNSS device based at least in part on the change in the ionospheric error value, or both, to:
a positioning engine of the GNSS device,
a processor of the GNSS device,
an application executed by the GNSS device,
a user interface of the GNSS device,
a second device via one or more transceivers of the GNSS device, or
any combination thereof.

20. The device of claim 19, wherein the one or more processors are configured to determine the second device is within a threshold distance of the GNSS device.

21. The device of claim 12, wherein, to output the indication of the change in the ionospheric error value, the one or more processors are configured to send the change in the ionospheric error value and a sum of delta geometry and delta clock values to a second device for determination of a change in the ionospheric error value with respect to a single GNSS frequency band.

22. The device of claim 12, wherein, to output the indication of the change in the ionospheric error value, the one or more processors are configured to use the change in the ionospheric error value and a sum of delta geometry and delta clock values to determine a change in the ionospheric error value with respect to a single GNSS frequency band.

23. An apparatus for enabling ionospheric error compensation in global navigation satellite system (GNSS)-based positioning, the apparatus comprising:
means for obtaining measurement information regarding a first dual-band carrier phase measurement and measurement information regarding a second dual-band carrier phase measurement, wherein:
the first dual-band carrier phase measurement and the second dual-band carrier phase measurement are of radio frequency (RF) signals transmitted by a satellite using a first frequency band and a second frequency band, and
the first dual-band carrier phase measurement is performed by a first device at a first epoch and the second dual-band carrier phase measurement is performed by the first device at a second epoch subsequent to the first epoch;
means for determining a change in an ionospheric error value from the first epoch to the second epoch based on a difference between the measurement information regarding the first dual-band carrier phase measurement and the measurement information regarding the second dual-band carrier phase measurement; and
means for outputting an indication of the change in the ionospheric error value.

24. The apparatus of claim 23, wherein the means for outputting the indication of the change in the ionospheric error value comprises means for including the information indicative of the change in the ionospheric error value in a differential carrier phase (DCP) update.

25. The apparatus of claim 23, wherein the means for outputting the indication of the change in the ionospheric error value comprises means for including information indicative of the change in the ionospheric error value in a State Space Representation (SSR) precise positioning engine (PPE) solution.

26. The apparatus of claim 23, wherein the means for outputting the indication of the change in the ionospheric error value comprises means for outputting a determined position of the first device, wherein the determined position is based at least in part on the ionospheric error value and Satellite-Based Augmentation System (SBAS) information received by the first device.

27. The apparatus of claim 23, further comprising means for determining that there is no cycle slip between the first dual-band carrier phase measurement and the second dual-band carrier phase measurement.

28. The apparatus of claim 23, wherein the means for outputting the indication of the change in the ionospheric error value comprises means for providing the change in the ionospheric error value, a determined position of the first device based at least in part on the change in the ionospheric error value, or both, to:
a positioning engine of the first device,
a processor of the first device,
an application executed by the first device,
a user interface of the first device,
a second device, or
any combination thereof.

29. The apparatus of claim 23, wherein the means for outputting the indication of the change in the ionospheric error value comprises means for sending the change in the ionospheric error value and a sum of delta geometry and delta clock values to a second device for determination of a change in the ionospheric error value with respect to a single GNSS frequency band.

30. A non-transitory computer-readable medium storing instructions for enabling ionospheric error compensation in global navigation satellite system (GNSS)-based positioning, the instructions comprising code for:
obtaining measurement information regarding a first dual-band carrier phase measurement and measurement information regarding a second dual-band carrier phase measurement, wherein:
the first dual-band carrier phase measurement and the second dual-band carrier phase measurement are of radio frequency (RF) signals transmitted by a satellite using a first frequency band and a second frequency band, and
the first dual-band carrier phase measurement is performed by a first device at a first epoch and the second dual-band carrier phase measurement is performed by the first device at a second epoch subsequent to the first epoch;
determining a change in an ionospheric error value from the first epoch to the second epoch based on a difference between the measurement information regarding the first dual-band carrier phase measurement and the measurement information regarding the second dual-band carrier phase measurement; and
outputting an indication of the change in the ionospheric error value.
